(19) United States
(12) Patent Application Publication
(10) Pub. No.: US 2024/0279093 A1
(43) Pub. Date: Aug. 22, 2024

(54) Radial Inflow Diffuser for Clarifier

(71) Applicant: Evoqua Water Technologies LLC, Pittsburgh, PA (US)

(72) Inventors: Michael R. Riffe, Gibsonia, PA (US); Palanivel Muthusamy, Chitlapakkam (IN); Umar Basheer, Tamil Nadu (IN); Pratheesh P. Perumal, Tamil Nadu (IN); Tulasiram Yama, Bangalore (IN); Sharath Ramesh, Karmataka (IN); Viswanathan Sampath, Chennai (IN); Suthahar Manoharan, Salem (DT) (IN); Raymund E. Mears, Grand Haven, MI (US); Theodore Kocol, Jasper, AL (US); Gopinath Rajendran, ChennaiTamil Nadu (IN); Joseph A. Herbst, Waukesha, WI (US); Timothy S. Crofton, South Yorkshire (GB); James R. Goodwin, Stafford (GB); Steven R. Lambert, Peterborough (GB); Andrew M. Crowther, Derbyshire (GB)

(73) Assignee: Evoqua Water Technologies LLC, Pittsburgh, PA (US)

(21) Appl. No.: 18/560,849

(22) PCT Filed: Aug. 4, 2022
(86) PCT No.: PCT/US22/39408

§ 371 Date: Nov. 14, 2023

Related U.S. Application Data
(60) Provisional application No. 63/354,277, filed on Jun. 22, 2022.
(60) Provisional application No. 63/229,154, filed on Aug. 4, 2021.

(51) Int. Cl. C02F 3/00; C02F 1/00

(52) U.S. Cl. CPC C02F 3/006; C02F 1/006; C02F 2209/40

(57) ABSTRACT

An apparatus for diffusing wastewater into a clarifier is disclosed. The apparatus has a rotationally symmetric hollow body having a plurality of flow distributors positioned about a perimeter of the rotationally symmetric hollow body and a baffle extending around a bottom end portion of the rotationally symmetric hollow body. The apparatus is dimensioned to fit within an influent well of the clarifier and be connectable to the clarifier on a top end portion of the rotationally symmetric hollow body. A wastewater treatment system including a clarifier and the apparatus is disclosed. A method of retrofitting a circular clarifier by providing the apparatus is also disclosed.

### CROSS-REFERENCE TO RELATED APPLICATIONS

This application claims priority under 35 U.S.C. § 119(e) to U.S. Provisional Application Ser. No. 63/229,154, titled “Clarifier for a Ballasted Flocculation Process Comprising a Radial Inflow Diffuser”, filed on Aug. 4, 2021, and U.S. Provisional Application Ser. No. 63/354,277 titled “Design and Optimization of Octagonal Inflow Diffuser for Circular Clarifier,” filed Jun. 22, 2022, each of which is incorporated herein by reference in its entirety for all purposes.

### FIELD OF TECHNOLOGY

Aspects and embodiments disclosed herein are generally directed to wastewater treatment systems, and more specifically, to treatment systems which utilize clarifiers and apparatuses which introduce wastewater into the same.

### SUMMARY

In accordance with one aspect, there is provided an apparatus for diffusing wastewater into a clarifier having a wastewater inlet fluidly connected to an influent well. The apparatus may comprise a rotationally symmetric hollow body having a plurality of flow distributors positioned about a perimeter of the rotationally symmetric hollow body. The apparatus may comprise a baffle extending around a bottom end portion of the rotationally symmetric hollow body. The apparatus may be dimensioned to fit within the influent well and connectable to the clarifier on a top end portion of the rotationally symmetric hollow body.

In some embodiments, the flow distributors define apertures open to flow through of the wastewater.

In some embodiments, the apertures cover 40%-60% of a surface area of the rotationally symmetric hollow body.

In some embodiments, the flow distributors extend vertically about the perimeter of the rotationally symmetric hollow body.

In some embodiments, the flow distributors form a grid structure, pattern structure, or serpentine structure, about the perimeter of the rotationally symmetric hollow body.

In some embodiments, the baffle extends around the bottom end portion of the rotationally symmetric hollow body at an angle of 45°-75° in an upward direction.

In some embodiments, the rotationally symmetric hollow body has a circular cross section.

In some embodiments, the rotationally symmetric hollow body has a polygonal cross section.

In some embodiments, the rotationally symmetric hollow body has an octagonal cross section.

In some embodiments, the baffle comprises a plurality of flow distributors and has a length selected to contact or extend to an interior surface of the influent well.

In some embodiments, the apparatus further comprises an overhead baffle extending around the top end portion of the rotationally symmetric hollow body.

In some embodiments, the apparatus is dimensioned to provide substantially uniform flow distribution of the wastewater.

In some embodiments, the apparatus is dimensioned to reduce or inhibit turbulence and/or recirculation within the clarifier.

In some embodiments, the apparatus is connectable to the clarifier by a coupler positioned on the top end portion of the rotationally symmetric hollow body.

In some embodiments, the apparatus is dimensioned to fit surrounding a shaft positioned upright in the clarifier.

In accordance with another aspect, there is provided a wastewater treatment system. The system may comprise a clarifier having a wastewater inlet fluidly connected to an influent well and a shaft positioned upright in the clarifier. The system may comprise an apparatus for diffusing wastewater into the clarifier comprising a rotationally symmetric hollow body surrounding the shaft and a baffle extending around a bottom end portion of the rotationally symmetric hollow body. In some embodiments, the apparatus positioned within the influent well in a flow path of the wastewater introduced through the wastewater inlet.

In some embodiments, the apparatus comprises a plurality of flow distributors positioned about a perimeter of the rotationally symmetric hollow body.

In some embodiments, the apparatus has an exterior diameter that is between about 40%-100% of an interior diameter of the influent well.

In some embodiments, the apparatus is dimensioned to provide substantially even flow distribution of the wastewater.

In some embodiments, the clarifier is a circular clarifier.

In some embodiments, the wastewater inlet is a lateral wastewater inlet.

In some embodiments, the influent well comprises an influent well substructure having a flared bottom.

In some embodiments, the influent well substructure is flared at an angle of between about 15°-75°.

In some embodiments, the influent well substructure has a length that is between about 30%-150% of a height of the influent well.

In some embodiments, the influent well substructure is dimensioned to reduce influent flow velocity of the wastewater.

In some embodiments, the influent well substructure is dimensioned to increase rise velocity of clarified water.

In some embodiments, the rotationally symmetric hollow body has a circular cross section.

In some embodiments, the rotationally symmetric hollow body has an octagonal cross section.

In accordance with another aspect, there is provided a method of retrofitting a circular clarifier having a lateral wastewater inlet fluidly connected to an influent well and a shaft positioned upright in the clarifier. The method may comprise providing an apparatus for diffusing wastewater into the circular clarifier comprising a rotationally symmetric hollow body having a plurality of flow distributors positioned about a perimeter of the rotationally symmetric hollow body and a baffle extending around a bottom end portion of the rotationally symmetric hollow body. The method may comprise positioning the apparatus within the influent well surrounding the shaft in a flow path of the wastewater introduced through the lateral wastewater inlet.

In some embodiments, the method may further comprise providing an influent well substructure having a flared bottom and securing the influent well substructure below the bottom end portion of the influent well.

In some embodiments, the method may further comprise controlling flow rate of the wastewater introduced through the lateral wastewater inlet to be greater than 1.15 m/s.

The disclosure contemplates all combinations of any one or more of the foregoing aspects and/or embodiments, as well as combinations with any one or more of the embodiments set forth in the detailed description and any examples.

### BRIEF DESCRIPTION OF THE DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1A is a schematic drawing of a clarifier, according to one embodiment;

FIG. 1B is a schematic drawing showing fluid flow within a clarifier, according to one embodiment;

FIG. 2A includes a schematic drawing and a line drawing of an inflow diffuser for a clarifier, according to one embodiment;

FIG. 2B is a schematic drawing of an alternate inflow diffuser for a clarifier, according to one embodiment;

FIG. 2C includes line drawings of an influent well and influent well substructure, according to one embodiment;

FIG. 3 is a box diagram of a wastewater treatment system having a secondary treatment clarifier, according to one embodiment;

FIG. 4 is a box diagram of a wastewater treatment system having a primary treatment clarifier, according to one embodiment;

FIG. 5 is a box diagram of a ballasted flocculation wastewater treatment system, according to one embodiment;

FIG. 6A includes a side view, top view, and side perspective view of an exemplary inflow diffuser, according to one embodiment;

FIG. 6B includes a side view, top view, and side perspective view of an exemplary inflow diffuser as positioned in an influent well, according to one embodiment;

FIG. 7A is a diagram of a clarifier showing an influent baffle, according to one embodiment;

FIG. 7B is a computational fluid dynamics (CFD) model showing fluid flow in the clarifier of FIG. 7A;

FIG. 8A is a diagram of a clarifier showing an inflow diffuser, according to one embodiment;

FIG. 8B is a computational fluid dynamics (CFD) model showing fluid flow in the clarifier of FIG. 8A;

FIG. 9A is a diagram of a clarifier without an influent baffle or diffuser, according to one embodiment;

FIG. 9B is a computational fluid dynamics (CFD) model showing fluid flow in the clarifier of FIG. 9A;

FIG. 10A is a diagram of a clarifier showing an influent baffle, according to one embodiment;

FIG. 10B is a computational fluid dynamics (CFD) model showing fluid flow in the clarifier of FIG. 10A;

FIG. 11A is a diagram of a clarifier showing an influent baffle, according to one embodiment;

FIG. 11B is a computational fluid dynamics (CFD) model showing fluid flow in the clarifier of FIG. 11A;

FIG. 12A is a diagram of a clarifier showing an inflow diffuser, according to one embodiment; and

FIG. 12B is a computational fluid dynamics (CFD) model showing fluid flow in the clarifier of FIG. 12A.

### DETAILED DESCRIPTION

Aspects and embodiments disclosed herein are directed to systems and methods for treating wastewater. As used herein the term “wastewater” includes, for example, municipal wastewater, industrial wastewater, agricultural wastewater, and any other form of liquid to be treated containing undesired contaminants. The term “wastewater” may be used to refer to raw wastewater or partially treated wastewater, such as primary treated wastewater or secondary treated wastewater. Aspects and embodiments disclosed herein may be utilized for primary wastewater treatment, secondary wastewater treatment, tertiary wastewater treatment, and combinations. Aspects and embodiments disclosed herein may remove sufficient contaminants from wastewater to produce product water that may be used for, for example, irrigation water, potable water, cooling water, boiler tank water, or for other purposes.

The systems and methods disclosed herein may include one or more clarifiers. Clarifiers are generally used to remove solid particulates or suspended solids from liquid by sedimentation for clarification and/or thickening. The solid particulates or suspended solids may be agglomerated by dosing the wastewater with one or more treatment agents upstream of the clarifier to form agglomerated solid contaminants. Inside the clarifier, the solid contaminants settle down to the bottom of the tank where they may be collected by a scraper mechanism, such as a rotating arm or rake. Concentrated solids, discharged from the bottom of the clarifier, are known as sludge. Clarified water rises through the clarifier and is discharged as treated effluent.

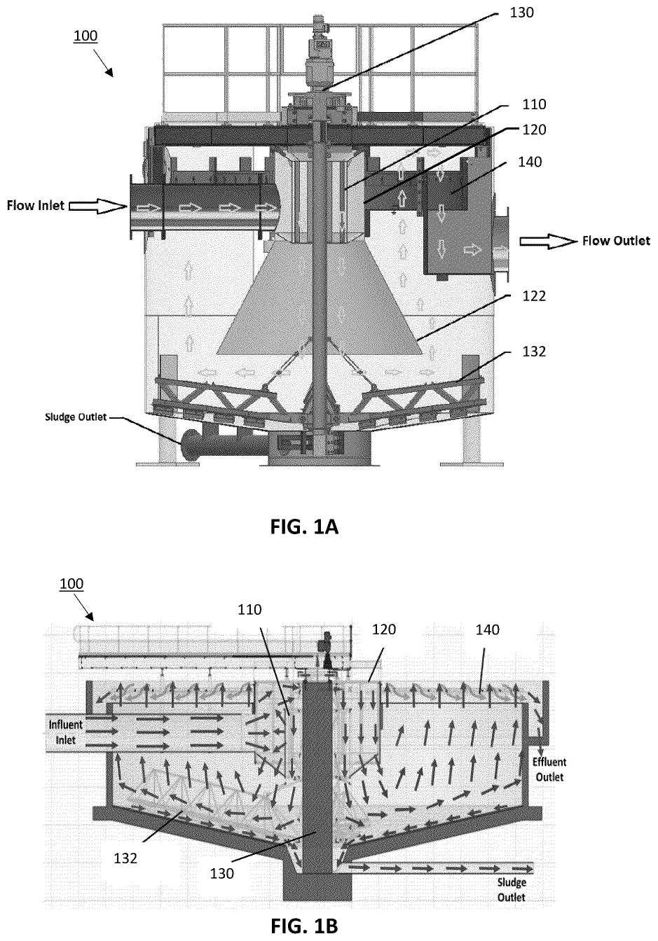

The systems and methods disclosed herein are directed to improvements in diffusing wastewater into clarifiers. An exemplary clarifier 100 is shown in FIG. 1A. FIG. 1B is a schematic diagram of clarifier 100 showing fluid flow paths within clarifier 100 represented by arrows. Influent wastewater enters the clarifier through the wastewater inlet. Influent wastewater passes through an apparatus for diffusing wastewater 110 (also referred to as “inflow diffuser” herein) into an influent well 120 of the clarifier 100. Clarifier 100 in FIG. 1A includes an influent well substructure 122 (not shown in FIG. 1B). After passing through the influent well 120 (and optional substructure 122), the particles or flocs settle out of the wastewater into a settling zone of the clarifier. Clarified water rises up within clarifier 100 and overflows into the launder 140 to exit through the effluent outlet of the clarifier 100. Settled solids form a sludge that exits the clarifier through a sump or sludge outlet positioned on a bottom surface of the clarifier 100. The bottom surface of the clarifier may be sloped to direct sludge to the sludge outlet, which may be positioned substantially centrally within the clarifier. A rake arm 132 may revolve around an upright shaft 130 to collect and/or direct sludge to the sludge outlet.

Exemplary clarifiers may be dimensioned to treat at least 1000 gallons per minute (gpm) (3785 liters per minute (lpm)) of wastewater. For example, the clarifiers disclosed herein may be dimensioned to treat 1000 gpm-3000 gpm (3785 lpm-11355 lpm), or at least 1000 gpm (3785 lpm), at least 2000 gpm (7570 lpm), up to 3000 gpm (11355 lpm). Such exemplary clarifiers may have a diameter of between about 10 ft-14 ft (3.04 m-4.27 m), for example, about 10 ft (3.04 m), about 12 ft (3.66 m), or about 14 ft (4.27 m). However, the systems and components described herein may be scaled for use in larger or smaller clarifiers.

The inflow diffuser may be designed to achieve desired flow conditions within the clarifier, increasing treatment capacity as measured by increased flow rate of the clarifier. In one aspect, the inflow diffuser may be designed to effectively distribute and dissipate energy of influent wastewater within the clarifier by enabling a uniform or substantially uniform fluid flow distribution inside the influent well and within the clarifier. The inflow diffuser may be employed to reduce or prevent carryover of solid particles or flocs in the effluent through the outlet launder.

In general, the inflow diffuser may comprise a rotationally symmetric hollow body. As used herein, “rotational symmetry,” may refer to an object having a substantially identical appearance when rotated by a partial turn. The inflow diffuser disclosed herein may have a horizontal cross-sectional area with rotational symmetry. In some embodiments, the inflow diffuser may have a circular cross-sectional area. In other embodiments, the inflow diffuser may have a polygonal cross section. For instance, the inflow diffuser may have a triangular, rectangular, hexagonal, heptagonal, octagonal, nonagonal, decagonal, or other polygonal cross-sectional area.

The inflow diffuser may be dimensioned to fit within the influent well of the clarifier. In some embodiments, the inflow diffuser may be dimensioned to fit surrounding a shaft positioned upright in the clarifier. In some embodiments, the inflow diffuser may have an overall diameter selected to contact the influent well. In some embodiments, the inflow diffuser or the hollow body of the inflow diffuser may have a diameter that is larger than the sludge outlet of the clarifier, for example, between 5%-10%, between 10%-15%, between 15%-20%, or between 20%-25% larger than the sludge outlet of the clarifier. In use, the inflow diffuser may direct settling solids into the sludge outlet. Exemplary inflow diffusers may have a diameter of 38 in-46 in (97 cm-117 cm), for example, 40 in-44 in (102 cm-107 cm), or about 40 in (102 cm), about 42 in (107 cm), or about 44 in (118 cm). In some embodiments, the hollow body may have an exterior diameter of 40%-80% of an interior diameter of the influent well, for example, 40%-50%, 50%-60%, 60%-70%, or 70%-80% of the interior diameter of the influent well. In some embodiments, the inflow diffuser (for example, as defined by the baffle of the inflow diffuser) may have an exterior diameter of 40%-100% of an interior diameter of the influent well, for example, 40%-50%, 50%-60%, 60%-70%, 70%-80%, 80%-90%, or 90%-100% of the interior diameter of the influent well.

The inflow diffuser may be connectable to the clarifier on a top end portion of the rotationally symmetric hollow body. For instance, the inflow diffuser may be connectable to the clarifier by a coupler positioned on the top end portion of the rotationally symmetric hollow body. The coupler may be or comprise a bracket, clamp, stop, bolt, screw, plate, or other fixture. The coupler may be configured to be coupled to the clarifier by welding, bolting, screwing, clamping, or other method.

The inflow diffuser may be dimensioned, for example, sized to achieve the desired flow conditions within the clarifier. The inflow diffuser may comprise one or more elements designed to achieve the desired flow conditions within the clarifier. For instance, in some embodiments, the inflow diffuser may be dimensioned to provide substantially uniform flow distribution of the wastewater within the clarifier. In some embodiments, the inflow diffuser may be dimensioned to reduce or inhibit turbulence and/or recirculation of the wastewater within the clarifier. Thus, the dimensions and/or components of the inflow diffuser may be selected or designed to achieve a desired flow condition.

In some embodiments, the inflow diffuser may have a plurality of flow distributors positioned about a perimeter of the rotationally symmetric hollow body. The flow distributors may be designed (for example, a number of flow distributors may be selected and/or dimensioned) to achieve desired flow conditions. The flow distributors may define apertures open to flow through of the wastewater. The apertures may cover 20%-80% of the surface area of the rotationally symmetric hollow body, for example, the apertures may cover 25%-75%, 30%-70%, 35%-65%, 40%-60%, 45%-55%, or about 50% of the surface area of the rotationally symmetric hollow body. Each aperture may cover 1%-100% of the area open to flow through, for example, 1%-50%, 1%-40%, 1%-30%, 1%-20%, 1%-10%, or 1%-5% of the area open to flow through. The apertures may be similarly sized, or one or more flow distributor or each flow distributor may be sized independently of others.

The flow distributors may comprise a valve or plate to direct wastewater, for example, through the apertures. In some embodiments, the flow distributors may comprise a damper. The damper may be configurable to be opened or closed. Optionally, the damper may be configurable to be partially opened or partially closed, as desired.

The flow distributors may extend in one or more directions about the perimeter of the rotationally symmetric hollow body. In some embodiments, the flow distributors, for example, at least some of the flow distributors, extend vertically about the perimeter of the rotationally symmetric hollow body. In some embodiments, the flow distributors, for example, at least some of the flow distributors, extend horizontally about the perimeter of the rotationally symmetric hollow body. In some embodiments, the flow distributors are positioned substantially parallel. In some embodiments, the flow distributors form a grid structure, pattern structure, or serpentine structure, about the perimeter of the rotationally symmetric hollow body. In some embodiments, the flow distributors define polygonal, rectangular, triangular, circular, elliptical, or other shape (including irregular shape) apertures open to flow through.

The inflow diffuser may comprise a baffle extending around a bottom end portion of the rotationally symmetric hollow body. The baffle may be dimensioned to direct the wastewater in an upward direction. The baffle may extend around the bottom end portion of the rotationally symmetric hollow body at an angle of 30°-90° or 45°-75°, for example, 30°-45°, 45°-60°, 50°-70°, 60°-75°, or 75°-90°, in an upward direction. In some embodiments, the baffle may have a length selected to contact or extend to an interior surface of the influent well. Thus, in some embodiments, the inflow diffuser is dimensioned to contact or extend to an interior surface of the influent well. The baffle may have a length selected to be 0.1%-25% of a height of the rotationally symmetric hollow body, for example, 0.1%-0.5%, 0.5%-1.0%, 1.0%-2.0%, 2.0%-3.0%, 3.0%-4.0%, 4.0%-5.0%, 5.0%-7.5%, 7.5%-10%, 10%-15%, 15%-20%, or 20%-25%. The length of the baffle may be defined as a dimension extending from a top end to a bottom end along a side of the baffle.

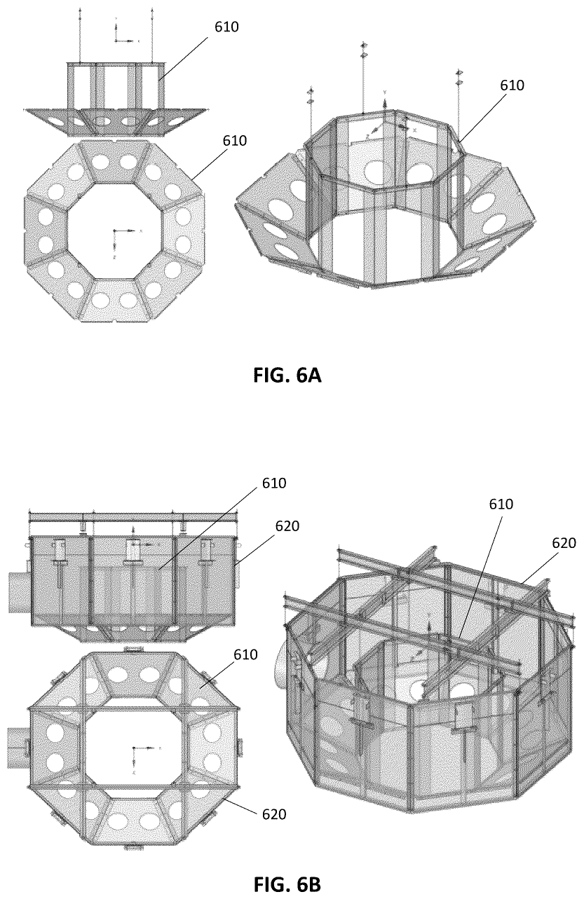

In some embodiments, the baffle may have a plurality of flow distributors to define apertures open to flow through of the wastewater. One exemplary inflow diffuser having flow distributors on the baffle is shown in FIG. 6A. The flow distributors may be designed (for example, a number of flow distributors may be selected and/or dimensioned) to achieve desired flow conditions. The apertures may cover 20%-80% of the surface area of the baffle, for example, the apertures may cover 25%-75%, 30%-70%, 35%-65%, 40%-60%, 45%-55%, or about 50% of the surface area of the baffle. Each aperture may cover 1%-100% of the area open to flow through, for example, 1%-50%, 1%-40%, 1%-30%, 1%-20%, 1%-10%, or 1%-5% of the area open to flow through. The apertures may be similarly sized, or one or more flow distributor or each flow distributor may be sized independently of others.

The flow distributors of the baffle may comprise a valve or plate to direct wastewater, for example, through the apertures. In some embodiments, the flow distributors may comprise a damper. The damper may be configurable to be opened or closed. Optionally, the damper may be configurable to be partially opened or partially closed, as desired. Additionally, the flow distributors of the baffle may extend in one or more directions about a surface area of the baffle. In some embodiments, the flow distributors, for example, at least some of the flow distributors, extend outward about the surface area of the baffle. In some embodiments, the flow distributors, for example, at least some of the flow distributors, may extend concentrically about a surface area of the baffle. In some embodiments, the flow distributors are positioned substantially parallel. In some embodiments, the flow distributors form a grid structure, pattern structure, or serpentine structure, on the baffle. In some embodiments, the flow distributors of the baffle define polygonal, rectangular, triangular, circular, elliptical, or other shape (including irregular shape) apertures open to flow through.

The inflow diffuser may comprise an overhead baffle extending around a top end portion of the rotationally symmetric hollow body. In some embodiments, one or more couplers may be positioned on the overhead baffle, for example, on a top end portion of the overhead baffle. The overhead baffle may be dimensioned to direct the wastewater in a downward direction. The overhead baffle may extend around the top end portion of the rotationally symmetric hollow body at an angle of 30°-90° or 45°-75°, for example, 30°-45°, 45°-60°, 50°-70°, 60°-75°, or 75°-90°, in an upward direction. In some embodiments, the overhead baffle may have a length selected to contact or extend to an interior surface of the influent well. The overhead baffle may have a length selected to be 0.1%-25% of a height of the rotationally symmetric hollow body, for example, 0.1%-0.5%, 0.5%-1.0%, 1.0%-2.0%, 2.0%-3.0%, 3.0%-4.0%, 4.0%-5.0%, 5.0%-7.5%, 7.5%-10%, 10%-15%, 15%-20%, or 20%-25%. In some embodiments, the overhead baffle may comprise flow distributors, as previously described with respect to the baffle. The length of the overhead baffle may be defined as a dimension extending from a top end to a bottom end along a side of the overhead baffle.

The inflow diffuser may be designed to provide an average velocity of wastewater at the influent well of 0.1 ft/s-0.2 ft/s (0.030 m/s-0.061 m/s) or 0.15 ft/s-0.2 ft/s (0.046 m/s-0.061 m/s), for example, at least 0.15 ft/s (0.046 m/s), 0.16 ft/s (0.049 m/s), 0.17 ft/s (0.052 m/s), 0.18 ft/s (0.055 m/s), 0.19 ft/s (0.058 m/s), or 0.2 ft/s (0.061 m/s). The inflow diffuser may be designed to provide an average velocity of wastewater at the settling zone of 0.05 ft/s-0.15 ft/s (0.016 m/s-0.046 m/s) or 0.07 ft/s-0.12 ft/s (0.021 m/s-0.037 m/s), for example, about 0.07 ft/s (0.021 m/s), 0.08 ft/s (0.024 m/s), 0.09 ft/s (0.027 m/s), 0.10 ft/s (0.030 m/s), 0.11 ft/s (0.033 m/s), or 0.12 ft/s (0.037 m/s).

The inflow diffuser may be formed of a material selected responsive to the intended use of the clarifier, for example, a material that is resistant to the type of wastewater to be treated. In general, the inflow diffuser may be formed of a durable material. Exemplary materials include steel, such as steel alloys, stainless steel, or carbon steel, fiberglass, or other material. The inflow diffuser may be treated for corrosion resistance. In certain embodiments, a steel inflow diffuser may be galvanized after fabrication for corrosion resistance. The influent well and/or influent well substructure may be coated with a material that provides corrosion resistance, such as epoxy or another polymer.

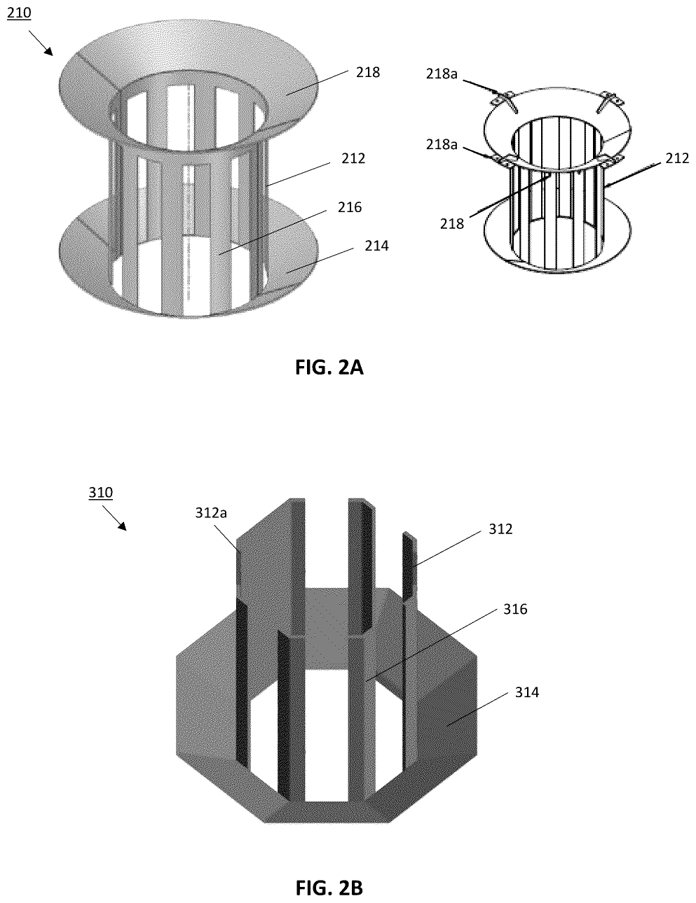

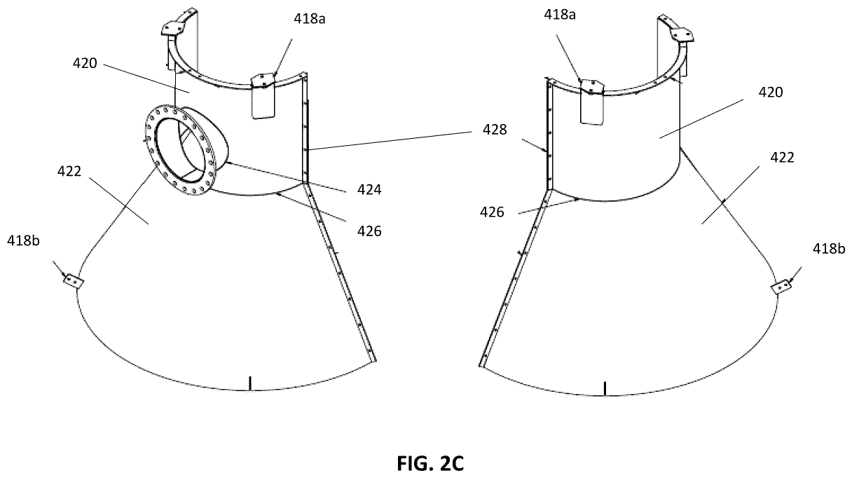

Exemplary inflow diffusers are shown in FIGS. 2A-2B. Inflow diffuser 210 of FIG. 2A includes a rotationally symmetric hollow body 212 having a circular cross-sectional area. Inflow diffuser 210 includes flow distributors 216 defining apertures extending in a vertical direction along hollow body 212. Inflow diffuser 210 includes baffle 214 extending around bottom end portion of the hollow body 212. Inflow diffuser 210 includes overhead baffle 218 comprising a plurality of couplers 218a (shown in the line drawing) positioned on a top end portion of hollow body 212. As shown in FIG. 2A, overhead baffle 218 may be angled in an upward direction. In some embodiments, the overhead baffle 218 may extend at the same angle as baffle 214. In other embodiments, overhead baffle 218 may extend at a different angle as baffle 214.

Inflow diffuser 310 of FIG. 2B is similar to inflow diffuser 210 of FIG. 2A including hollow body 312, flow distributors 316 and baffle 314, except that inflow diffuser 310 has a rotationally symmetric hollow body 312 having a polygonal cross section. In particular, hollow body 312 of inflow diffuser 310 has an octagonal cross-sectional area. As shown in FIG. 2B, flow distributors may define angles or corners of a polygonal hollow body, such as hollow body 312. Furthermore, one or more flow distributor, such as flow distributor 316a, may be sized differently than other flow distributors. In exemplary inflow diffuser 310, flow distributor 316a is configured to be positioned adjacent a wastewater inlet of the clarifier. Exemplary inflow diffuser 310 is shown without an overhead baffle or any couplers, however inflow diffuser 310 may include one or more coupler, optionally positioned on an overhead baffle, as shown in FIG. 2A.

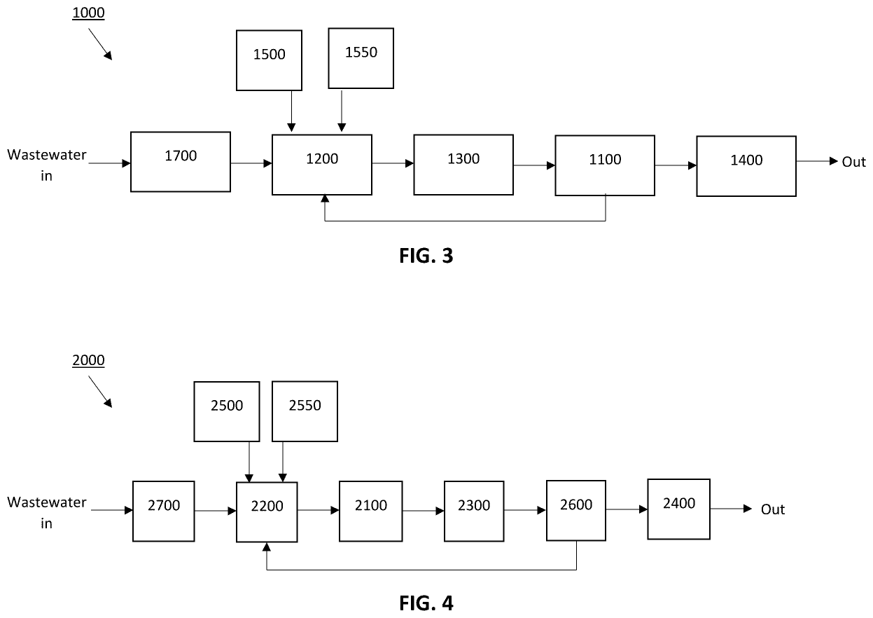

The inflow diffuser may be employed in a wastewater treatment system including a clarifier. Exemplary wastewater treatment systems are shown in FIGS. 3-5 and described in more detail below. The clarifier may have a wastewater inlet fluidly connected to an influent well and a shaft positioned upright in the clarifier. The inflow diffuser may be positioned in the clarifier in a flow path of the wastewater introduced through the wastewater inlet, for example, surrounding the shaft. The clarifier may be a circular clarifier. Alternatively, the clarifier may be rectangular or have a polygonal perimeter.

The wastewater inlet of the clarifier may be a lateral wastewater inlet. The wastewater inlet may direct wastewater into the influent well. The influent well may be a hollow structure having an inlet fluidly connected to the wastewater inlet of the clarifier and an outlet on a bottom end. The influent well may be positioned to fit surrounding a shaft positioned upright in the clarifier. Thus, in use, the influent well, inflow diffuser, and central shaft may be arranged concentrically within the clarifier. However, in other embodiments, the influent well, inflow diffuser, and shaft need not be positioned concentrically, for example, may have offset centers. In some embodiments, the influent well, inflow diffuser, and shaft may be positioned substantially centrally within the clarifier. In other embodiments, the influent well, inflow diffuser, and shaft may be positioned non-centrally within the clarifier. The influent well may have a cross-sectional area similar to the perimeter of the clarifier. The influent well may have a circular, rectangular, or polygonal cross-sectional area.

In some embodiments, the influent well may comprise an influent well substructure. The influent well substructure may extend around the bottom end or outlet of the influent well. The influent well substructure may be dimensioned to reduce flow velocity of the wastewater, for example, as the wastewater travels through the flow path into the clarifier. By reducing turbulence and recirculation, the influent well substructure may be dimensioned to increase rise velocity of the clarified water.

The influent well substructure may have a flared bottom. The influent well substructure may extend around the bottom end portion of the rotationally symmetric hollow body at a flared angle. The flared angle may be 15°-75° or 30°-60°, for example, 15°-30°, 30°-45°, 45°-60°, 45°-50°, 50°-55°, 55°-60°, or 60°-75°. The influent well substructure may have a length selected to be 30%-150% of a height of the influent well, for example, 30%-50%, 50%-60%, 60%-70%, 70%-80%, 80%-90%, 90%-100%, 100%-125%, or 125%-150%. The length of the influent well substructure may be defined as a dimension extending from the top end to the bottom end along a side of the substructure. In some embodiments, the influent well substructure may be flared at an angle and/or have a length selected to accommodate a turn buckle of the rake arm. The turn buckle may generally extend from the upright shaft to the rake arm at a point about 60%-70% of a length of the rake arm.

The influent well substructure may be dimensioned to increase distilling time of the wastewater while maintaining or not decreasing clarifying surface area of the unit. For example, the influent well substructure may have a flared angle selected to provide a retention time of solids within the influent well and influent well substructure of less than 5 minutes, for example, 15 seconds to 5 minutes, 30 seconds to 2 minutes, or 30 seconds to 1 minute. For comparison, conventional clarifiers tend to have a solids retention time of about 5 minutes to 15 minutes.

The influent well substructure may have a bottom end diameter dimensioned to provide a rise velocity of clarified water within the clarifier of at least about 0.25 ft/s (0.076 m/s), for example, at least about 0.5 ft/s (0.15 m/s), at least about 0.75 ft/s (0.23 m/s), at least about 0.85 ft/s (0.26 m/s), at least about 0.9 ft/s (0.27 m/s), at least about 0.95 ft/s (0.29 m/s), or between about 0.5 ft/s (0.15 m/s) and about 1.0 ft/s (0.3 m/s).

The influent well substructure may be secured to the influent well, for example, to a bottom end portion of the influent well. The influent well substructure may be connectable to the influent well on a top end portion of the influent well substructure. For instance, the influent well substructure may be connectable to the influent well by a coupler positioned on the top end portion of the influent well substructure. The coupler may be or comprise a bracket, clamp, stop, bolt, screw, plate, or other fixture. The coupler may be configured to be coupled to the influent well by welding, bolting, screwing, clamping, or other method.

The influent well and/or influent well substructure may be formed of a material selected responsive to the intended use of the clarifier, for example, a material that is resistant to the type of wastewater to be treated. In general, the influent well and/or influent well substructure may be formed of a durable material. Exemplary materials include steel, such as steel alloys, stainless steel, or carbon steel, fiberglass, or other material. The influent well and/or influent well substructure may be treated for corrosion resistance. In certain embodiments, a steel influent well and/or influent well substructure may be galvanized after fabrication for corrosion resistance. The influent well and/or influent well substructure may be coated with a material that provides corrosion resistance, such as epoxy or another polymer.

FIG. 2C includes line drawings of a first side and second side of influent well 420 and influent well substructure 422. As shown in the drawings of FIG. 2C, influent well 420 may include an inlet 424 for influent wastewater. Influent well 420 may include one or more coupler 418a positioned on a top end surface of influent well 420. Influent well substructure 422 may include one or more coupler 418b positioned on a bottom surface of influent well substructure 422. Influent well 420 and influent well substructure 422 may be assembled at joint 426 by welding, screwing, or otherwise fixing influent well substructure 422 to influent well 420. In some embodiments, one or both of influent well 420 and influent well substructure 422 may be formed of a plurality of pieces fixed together at joint 428 by welding, screwing, or other method.

The systems and methods disclosed herein may include chemical treatment of wastewater in coagulation units using coagulants. The systems and methods disclosed herein may include physical treatment of wastewater in flocculation units using flocculants, for example, polymer. These methods may be employed to remove organic and/or inorganic contaminants from the wastewater as necessary. A clarifier may be positioned downstream from a coagulant and/or flocculant dosing unit to settle aggregated solids formed by use of the coagulants and/or flocculants.

As used herein, “coagulation” refers to a chemical process in which non-settleable particles are destabilized and attract to form clumps. Coagulation is a chemical process achieved by neutralizing the particles and reducing the repelling force between them. Coagulants generally alter the chemistry of the suspension to induce settling. Examples of coagulants generally include inorganic salts of aluminum and iron, for example, ferric chloride and ferric sulfates. These salts generally neutralize the charge on the particles and hydrolyze to form insoluble precipitates of the particles. Other examples of coagulants include organic coagulants, such as, diallyldimethylammonium chloride (DADMAC). Other coagulants may be used.

As used herein, “flocculation” refers to a physical process in which particle clumps are physically joined to form larger particle masses and then a precipitate. Flocculation is a physical process of clumping. Flocculation can be achieved by physical agitation, for example, by mixing. Optionally a flocculant can be added to aid in the flocculation process. Flocculants generally provide a base for the settling particles to physically attach and grow into a floc or flake. Exemplary flocculants include, for example, polymers, for example, high molecular weight polymers, medium molecular weight polymers, low molecular weight polymers, and cationic or anionic polymers.

In certain treatment processes a flocculant may be used in combination with a coagulant to generate larger particles for faster settling. For instance, a coagulant may be added to clump the non-settleable particles together and a flocculant may be added to gather the small clumps formed by the coagulation and form larger clumps. However, a flocculant and coagulant need not be used together. Coagulants and flocculants may operate under different conditions. Thus, the conditions of the suspension to be treated, for example, pH, temperature, and composition, may be considered when selecting whether to dose the water with a coagulant, flocculant, or both. In some embodiments, water may be dosed with a coagulant during one stage of treatment and dosed with a flocculant during another stage of treatment.

In some embodiments, the systems and methods for the treatment of wastewater may involve biological treatment of the wastewater in aerobic and/or anaerobic biological treatment units. Biological treatment units may be selected to reduce the total organic content and/or biochemical oxygen demand of the wastewater. A clarifier may be used downstream from a biological treatment unit to settle biologically activated sludge.

The biological treatment units or vessels typically include bacteria that break down components of the wastewater, for example, organic components. The biological treatment processes in the biological treatment units or vessels may reduce the total organic content and/or biological organic content of the wastewater. Biological treatment processes can result in the formation of biological floc.

Biological treatment typically utilizes an aeration tank(s) that contains microorganisms that ingest contaminants in an effluent to form biological flocs. Oxygen is typically fed into the aeration tank(s) to promote growth of biological flocs. The microorganisms of the biological sludge consume and digest suspended and colloidal organic solids by breaking down complex organic molecules into simple waste products that may, in turn, be broken down by other microorganisms. The microorganisms in the aeration tank grow and multiply as allowed by the quantities of air and consumable solids available. The combination of effluent, or in some cases raw sewage, and biological flocs is commonly known as “mixed liquor.”

Thus, the methods disclosed herein may generally involve the removal of flocculated solids formed by the flocculation process from treated wastewater. Methods may also involve the removal of coagulated solids formed by a coagulation process from treated wastewater. These forms of biological, physical, and/or chemical treatment typically result in the formation of sludge. As used herein, “sludge” refers to a residual, solids-containing material that is produced as a by-product during treatment of the wastewater. In certain embodiments, sludge may comprise dead bacteria and byproducts of the biological treatment. The clarifiers disclosed herein are employed for removal of the sludge from the wastewater after undergoing biological, physical, and/or chemical treatment.

In some embodiments, the clarifier may be a secondary treatment clarifier. Wastewater treatment systems 1000 having a secondary treatment clarifier 1100, as shown generally in FIG. 3, are disclosed herein. The wastewater treatment system 1000 may include a primary treatment unit 1200 having an inlet fluidly connected to a source of wastewater and a primary treated water outlet, a biological treatment unit 1300 having an inlet fluidly connected to the primary treated water outlet and a biologically treated water outlet, a clarifier 1100 having an inlet fluidly connected to the biologically treated water outlet, an effluent outlet, and a sludge outlet. In some embodiments, the sludge outlet may be fluidly connected to a recycle inlet of the primary treatment unit 1200 and/or the biological treatment unit 1300 for recycle of biologically activated solids. A source of a coagulant 1500 and/or a source of a flocculant 1550 may be fluidly connected to the primary treatment unit 1200 and/or the biological treatment unit 1300 to produce a dosed wastewater. In some embodiments, the system may include an optional post-treatment unit 1400 fluidly connected to the effluent outlet of the clarifier 1100. The system may additionally include an optional pre-treatment unit 1700 for removal of gross solids. Other variations of wastewater treatment systems are within the scope of the disclosure.

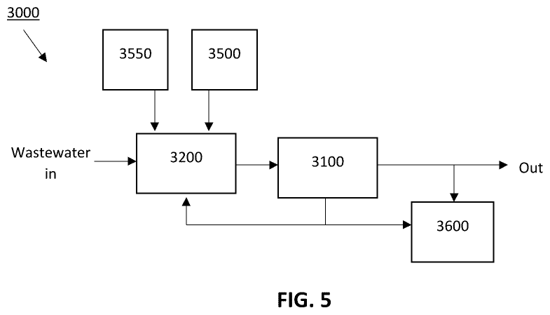

In some embodiments, the clarifier may be a primary treatment clarifier. Wastewater treatment systems 2000 having a primary treatment clarifier 2100, as shown generally in FIG. 4, are disclosed herein. The wastewater treatment system 2000 may include a clarifier 2100 having an inlet fluidly connected to a source of wastewater and an effluent outlet and a solids outlet, a biological treatment unit 2300 having an inlet fluidly connected to the effluent outlet and a biologically treated water outlet, a solids-liquid separation unit 2600 having an inlet fluidly connected to the biologically treated water outlet, an effluent outlet, and a solids outlet. The solids-liquid separation unit may be a clarifier, thickener, settling tank, or other solids-liquid separation unit. In some embodiments, the solids outlet may be fluidly connected to a recycle inlet of the clarifier 2100 and/or the biological treatment unit 2300 for recycle of biologically activated solids. A source of a coagulant 2500 and/or a source of a flocculant 2550 may be fluidly connected to the clarifier 2100 or upstream from the clarifier 2100, for example to a contact tank 2200 to produce a dosed wastewater. In some embodiments, the system may include an optional post-treatment unit 2400 fluidly connected to the effluent outlet of the solids-liquid separation unit 2600. The system may additionally include an optional pre-treatment unit 2700 for removal of gross solids. Other variations of wastewater treatment systems are within the scope of the disclosure.

In certain embodiments, the clarifiers disclosed herein may be employed in a ballasted flocculation system. Exemplary ballasted flocculation systems are disclosed in U.S. Pat. No. 11,242,271, titled “REMOVING HEAVY METALS IN A BALLASTED PROCESS,” which is incorporated herein by reference in its entirety for all purposes. Aspects and embodiments disclosed herein include using a ballasted flocculant or activated sludge. In some embodiments, magnetite may be utilized as the ballast material. Due to the high density (about 5.2 g/cm³) and hydrophobic characteristics, magnetite tends to settle rapidly when it is introduced to the clarifier. There is a need, then, to increase flow rate of the ballasted flocculation process. However, when increasing flow rate, there is increased turbulence and recirculation in the clarifier that may cause some loss of ballast through the launder. The inflow diffuser designs described herein may be employed to reduce or prevent turbulence and/or recirculation in the clarifier, thus reducing or preventing ballast loss through the clarified effluent.

The wastewater treatment systems disclosed herein may comprise a ballasted reactor having an inlet in fluid communication with an effluent outlet of a pre-treatment subsystem. The ballasted reactor may further have an outlet in fluid communication with a clarifier. Typically, in a ballasted reactor, inorganic contaminants can be aggregated to form the “ballasted floc,” which refers to aggregations of suspended particles or solids with a weighting agent or ballast, and may also include biological, physical, and/or chemical floc. Impregnating the floc with a ballast will generally cause the floc to settle more rapidly in the clarifier than it would otherwise settle, facilitating separation.

Flow rate of the wastewater introduced through the lateral wastewater inlet into the clarifier may be increased in a ballasted flocculation system. In some embodiments, flow rate of the ballasted floc dosed wastewater into the clarifier may be controlled to be greater than 1.15 m/s, for example, greater than 1.25 m/s, greater than 1.5 m/s, or up to at least about 2.0 m/s. The systems disclosed herein, for example, the inflow diffuser, may reduce or prevent turbulence and/or recirculation within the clarifier, even at such high influent flow rates.

In some embodiments, ballast material may be separated from the clarified water (effluent) or sludge (waste) stream and recovered. For example, the withdrawn waste or effluent may be directed to a ballast recovery unit. In exemplary embodiments, the withdrawn waste or effluent may be directed to a CoMag® and/or BioMag® (Evoqua Water Technologies LLC, Pittsburgh, PA) system or a tertiary filter. From the filter the ballast material may be captured and returned to the system upstream with the return activated sludge.

Ballasted flocculation systems are disclosed herein. One exemplary ballasted flocculation system 3000 is shown in FIG. 5. The ballasted flocculation system 3000 may be positioned downstream from a primary treatment system and/or secondary treatment system. In certain embodiments, ballasted flocculation system 3000 is positioned downstream from a biological secondary treatment system, such as biological treatment units 1300, 2300 shown in FIGS. 3 and 4, respectively. In particular, ballasted flocculation system 3000 may be positioned downstream from clarifier 1100 or solids-liquid separation unit 2600.

Ballasted flocculation system 3000 as shown in FIG. 5 may include a ballasted reactor 3200 fluidly connected to a source of a wastewater feed and a ballasted flocculant dosing agent 3550. In some embodiments, a source of a coagulant 3500 may be fluidly connected to the ballasted reactor 3200. The ballasted flocculation system 3000 may include a clarifier 3100 having an inlet for dosed wastewater fluidly connected to an outlet of the ballasted reactor 3200, an effluent outlet, and a sludge outlet. The sludge outlet may be fluidly connected to the ballasted reactor 3200 for return of ballast material. The ballasted flocculation system 3000 may also include a ballast recovery subsystem 3600 downstream from the sludge outlet and/or effluent outlet of the clarifier 3100. In some embodiments, the ballasted reactor 3200 may be a biological reactor, comprising bacteria for biological treatment of the wastewater feed.

In some embodiments, the ballasted floc may be directed to a ballast recovery subsystem to produce recovered ballast. The wastewater treatment system may further comprise a ballast recovery subsystem configured to receive ballasted floc from the outlet of the clarifier and recirculate ballast within the various operations of the water treatment system. The recovered ballasted floc may be recirculated and conveyed to at least one of the wastewater feed, the dosed wastewater, the effluent, and the treated wastewater.

The ballast particles are generally highly recoverable and reusable (up to 99%), which further helps keep operational costs low. With the substantial acceleration of settling, the footprint of the clarifier utilized in the systems disclosed herein may be much smaller with better effluent quality (for example, lower suspended solids).

In accordance with some embodiments the ballast may comprise a magnetic material, for example, a metal oxide, and/or a ceramic material, for example, sand. The magnetic material may be magnetite. The ballast may be provided in the form of small particles or as a powder. The particle sizes of the powder may be in the range of, for example, from about 5 μm to about 100 μm in diameter, with an average diameter of about 20 μm. The particle size of the ballast, for example, may be less than about 100 μm. In some embodiments, the particle size of the ballast may be less than about 40 μm. In some embodiments, the particle size of the ballast may be less than about 20 μm. In some embodiments, the particle size of the ballast may be between about 80 μm to about 100 μm; between about 60 μm to about 80 μm; between about 40 μm to about 60 μm; between about 20 μm to about 40 μm; or between about 1 μm to about 20 μm. Different sizes of ballast may be utilized in different embodiments depending, for example, on the nature and quantity of floc and/or other suspended solids to be removed in a settling process. For instance, the ballast and size of the ballast may be selected based on the nature and quantity of floc. The benefit of ballast is generally to increase the efficiency of separating liquids from solids which increases the efficiency of the clarification performed in the solids-liquid separation system and/or or a thickening process performed downstream from the solids-liquid separation in a fluid recirculation to the pre-treatment subsystem.

The ballast may be introduced at a concentration of between about 5,000 mg/L and 12,000 mg/L. For example, the treatment process can start with a low concentration of ballast, which gradually gets increased. Alternatively, the treatment process can start with a high concentration of ballast, which gradually gets reduced. After a predetermined operation time, the fresh ballast introduced into the system can be decreased and the treatment can operate by recirculated ballast. Generally, about 0.2% of ballast by weight may be lost during operation.

According to one embodiment, the ballast (otherwise referred to herein as a “weighting agent”) may be a magnetic ballast. The magnetic ballast may comprise an inert material. The magnetic ballast may comprise a ferromagnetic material. The magnetic ballast may comprise iron-containing material. In certain embodiments, the magnetic ballast may comprise an iron oxide material. For example, the magnetic ballast may comprise magnetite (available from, for example, Quality Magnetite, LLC, Kenova, WV). Magnetite has a much higher density, approximately 5.1 g/cm³, than typical floc formed in biological, physical, and/or chemical wastewater treatment methods. Magnetite is a fully oxidized iron ore (Fe₃O₄). Magnetite is inert, does not rust, and does not react or otherwise interfere with chemical or biological floc. Magnetite also does not stick to metal, meaning that while it is attracted to magnets, it does not attach to metal surfaces, such as steel pipes. The magnetic ballast may have a particle size that allows it to bind with biological and chemical flocs to provide enhanced settling or clarification, and allows it to be attracted to a magnet so that it may be separated from the flocs.

Generally, magnetite ballast, unlike sand, may allow for the magnetite particles to impregnate existing floc. In accordance with some embodiments, a magnetic drum provided in the ballast recovery subsystem may be used to separate the aggregates from the magnetic ballast in an efficient manner.

Although magnetite may be utilized as ballast material in some aspects disclosed herein, these aspects are not limited to the use of magnetite as the ballast. Other materials, including sand, as discussed below may additionally or alternatively be used as a ballast material. Further materials which may additionally or alternatively be used as ballast materials include any materials which may be attracted to a magnetic field, for example, particles or powders comprising nickel, chromium, iron, and/or various forms of iron oxide.

According to other embodiments, the ballast may be sand. Sand ballasted systems may implement larger ballast sizes to effectively recover the ballast. For instance, sand particles may range in size from 50 μm to about 2000 μm. Sand ballast is non-magnetic. Sand ballasted systems and methods may implement the use of cleaning agents to separate the aggregated solids from the sand particle ballast. The use of a cleaning agent may be related to the large surface area of the sand ballast where solid particulates attach to the sand material. Therefore, mechanical energy alone (i.e., shearing forces from a vortex flow pattern) may generally be insufficient for removing aggregated solids form the surface of the sand particle and chemical methods may be needed to react with and dissolve chemical bonds present on the surface of the sand particle that bind the sand to the aggregated solids. In some embodiments, aggregated solids may be removed from the surfaces of the sand particles in a hydrocyclone. Thus, in certain embodiments, ballast recovery subsystems disclosed herein may comprise a hydrocyclone.

The wastewater treatment systems disclosed herein may also comprise a controller. The controller may be operatively connected to a source of a dosing agent, such as a coagulant, flocculant, and/or ballasted flocculant, as shown in FIGS. 3-5. The controller may be programmed to dose the wastewater according to a predetermined treatment regimen or a concentration of contaminants in the wastewater, for example, determined by a sensor operatively connected to the controller and/or predictive data generated.

The controller may also be operatively connected to a pump or valve configured to direct recycled solids from a sludge outlet of the clarifier to an upstream reactor, such as a contact tank, biological reactor, and/or ballasted reactor, as shown in FIGS. 3-5. The controller may be configured to recycle 5%-25% of solids separated from the sludge outlet to the upstream reactor, for example, the controller may be configured to recycle 5%-10%, 10%-15%, 15%-25%, or about 5%, about 10%, about 15%, about 20%, or about 25% of solids separated from the sludge outlet. The systems disclosed herein may comprise additional valves and/or pumps for directing process streams in accordance with the methods disclosed herein. Furthermore, one or more of the additional valves and/or pumps may be operatively connected to the controller.

In some embodiments, the wastewater treatment systems disclosed herein may comprise additional dosing agents, such as a source of a pH adjustment agent, a source of an adsorbant, and a source of a precipitant. The dosing agents may be fluidly connected upstream from a clarifier, for example, fluidly connected to a contact tank, biological reactor, and/or ballasted reactor, as shown in FIGS. 3-5. The dosing agents may be introduced in amounts effective to improve settleability of solids in the clarifier. In some embodiments, one or more source of a dosing agent may be operatively connected to the controller. The controller may be programmed to dose the wastewater according to a predetermined treatment regimen or a concentration of contaminants in the wastewater, for example, determined by a sensor operatively connected to the controller and/or predictive data generated.

The controller may be associated with or more processors typically connected to one or more memory devices, which can comprise, for example, any one or more of a disk drive memory, a flash memory device, a RAM memory device, or other device for storing data. The memory device may be used for storing programs and data during operation of the system. For example, the memory device may be used for storing historical data relating to the parameters over a period of time, as well as operating data. In some embodiments, the controller disclosed herein may be operably connected to an external data storage. For instance, the controller may be operable connected to an external server and/or a cloud data storage.

Any controller disclosed herein may be a computer or mobile device or may be operably connected to a computer or mobile device. The controller may comprise a touch pad or other operating interface. For example, the controller may be operated through a keyboard, touch screen, track pad, and/or mouse. The controller may be configured to run software on an operating system known to one of ordinary skill in the art. The controller may be electrically connected to a power source.

The controller disclosed herein may be digitally connected to the one or more components. The controller may be connected to the one or more components through a wireless connection. For example, the controller may be connected through wireless local area networking (WLAN) or short-wavelength ultra-high frequency (UHF) radio waves. The controller may be coupled to a memory storing device or cloud-based memory storage.

The controller disclosed herein may be configured to transmit data to a memory storing device or a cloud-based memory storage. Such data may include, for example, operating parameters, measurements, and/or status indicators of the system components. The externally stored data may be accessed through a computer or mobile device. In some embodiments, the controller or a processor associated with the external memory storage may be configured to notify a user of an operating parameter, measurement, and/or status of the system components. For instance, a notification may be pushed to a computer or mobile device notifying the user. Operating parameters and measurements include, for example, properties of the wastewater to be treated or other process stream, properties of the wastewater, solids, and/or rising clarified water within the clarifier, properties of the effluent, and/or properties of the sludge. Status of the system components may include, for example, settle times, and whether any system component requires regular or unplanned maintenance. However, the notification may relate to any operating parameter, measurement, or status of a system component disclosed herein. The controller may further be configured to access data from the memory storing device or cloud-based memory storage. In certain embodiments, information, such as system updates, may be transmitted to the controller from an external source.

It should be noted that multiple controllers may be programmed to work together to operate the system. For example, one or more controller may be programmed to work with an external computing device. In some embodiments, the controller and computing device may be integrated. In other embodiments, one or more of the processes disclosed herein may be manually or semi-automatically executed.

In accordance with another aspect, the systems and methods disclosed herein include using a granular activated sludge. Granular activated sludge may refer to rapid settling sludge as measured by the Sludge Volume Index (SVI). SVI is a mathematical calculation that takes into account a 30-minute settleability test result and an activated sludge mixed liquor suspended solids (MLSS) test result to produce a number (or index) that describes the ability of the sludge to settle and compact. SVI may give a more accurate picture of the sludge settling characteristics than settleability or MLSS alone. The SVI formula is shown below.

$$S V I ( mL / g ) = \frac{Settled Sludge Volume ( mL / L )}{Mixed Liquor Suspended Solids ( g / L )} \times 1 , 000$$

SVI may generally provide an indication of changes occurring in the activated sludge treatment process. By trending SVI data over a period of time, operators may discover potential problems and even prevent certain problems from occurring. The optimum operating SVI is generally specific to the wastewater treatment plant. SVI should ideally be determined when the treatment plant is running at an optimum level. The measured or calculated SVI during optimum plant performance may be used as a benchmark.

The SVI 5 (settleability reading at 5 minutes) of granular activated sludge is generally equivalent to about an SVI 30 (settleability reading at 30 minutes) of conventional sludge. The use of granular activated sludge may allow operation of the biological reactor at a much higher MLSS concentration (for example, around 9-10 g/L), reducing the necessary aeration reactor volume and operation cost. Granular activated sludge is typically used in sequencing batch reactor (SBR) systems. However, to form the granules during operation, there is a need to maintain vertical flow within the reactor. With an SBR, this requires mounting the effluent launders on top of the reactors with a spacing of not more than 6 m. The launders add complexity to the system, lessening their appeal to broader market, particularly when large plants (which tend to be based on conventional activated sludge) need to be converted to granular sludge plants. In such plants, the existing secondary clarifier may need to be repurposed or abandoned altogether.

The systems and methods disclosed herein may instead use granular activated sludge in the clarifier, such as a secondary clarifier positioned downstream from a biological treatment unit, which maintains vertical flow. The granular activated sludge may be collected and returned to the upstream biological treatment unit. To maintain a high relative concentration of granular activated sludge in the return, the systems and methods remove flocculant sludge, which may be directed to waste.

In accordance with one aspect, methods of retrofitting wastewater treatment systems are disclosed herein. The methods may generally include retrofitting a clarifier, for example, a circular clarifier, of a wastewater treatment system. In some embodiments, the methods include providing an inflow diffuser or apparatus for diffusing wastewater into the circular clarifier. The methods may include positioning the inflow diffuser within the influent well surrounding the shaft in a flow path of the wastewater introduced through the lateral wastewater inlet. In some embodiments, the methods may further include providing an influent well substructure having a flared bottom. The methods may include securing the influent well substructure below a bottom end portion of the influent well. In some embodiments, the methods may include providing a controller, operatively connecting the controller to one or more component of a wastewater treatment system as disclosed herein, and/or programming the controller to operate the clarifier and/or wastewater treatment system in accordance with a predetermined regimen, for example, at a predetermined wastewater flow rate.

In accordance with another aspect, methods of controlling, e.g., reducing or preventing, turbulence and/or recirculation within a circular clarifier are disclosed herein. The methods may generally include designing a clarifier or retrofitting an existing clarifier, for example, a circular clarifier, of a wastewater treatment system to include an inflow diffuser or apparatus for diffusing wastewater into the circular clarifier. The methods may include directing wastewater into a clarifier through an inflow diffuser or apparatus for diffusing wastewater. Thus, in some embodiments, the methods include providing an inflow diffuser. The methods may include positioning the inflow diffuser within the influent well surrounding the shaft in a flow path of the wastewater introduced through the lateral wastewater inlet. In some embodiments, the methods may further include directing the wastewater through an influent well substructure having a flared bottom. Thus, the methods may include providing an influent well substructure. The methods may include securing the influent well substructure below a bottom end portion of the influent well.

The methods may further include controlling flow rate of the wastewater introduced into the clarifier. Flow rate of the wastewater introduced through the lateral wastewater inlet into the clarifier may be controlled to be greater than 1.15 m/s, for example, greater than 1.25 m/s, greater than 1.5 m/s, or up to at least about 2.0 m/s. In some embodiments, the methods may include providing a controller, operatively connecting the controller to one or more component of a wastewater treatment system as disclosed herein, and/or programming the controller to operate the clarifier and/or wastewater treatment system in accordance with a predetermined regimen, for example, at a predetermined wastewater flow rate.

### EXAMPLES

### Example 1: Radial Inflow Diffuser Design with Octagonal Hollow Body

Computational fluid dynamics (CFD) was used to model several inflow diffuser designs. A radial inflow diffuser having a hollow body with an octagonal cross-sectional area was shown to be superior to other modeled designs. In particular, the radial inflow diffuser with octagonal design was shown to play a critical role in eliminating operational issues and improving performance of a circular clarifier when operating at maximum influent flow capacity. The radial diffuser having an octagonal design was shown to dissipate influent flow reducing or preventing non-uniform flow distribution, high turbulence and recirculation within the influent well and inside the clarifier, and floc carryover through the outlet launder.

To dissipate the high energy and high velocity of influent wastewater and to achieve uniform fluid flow distribution inside the influent well, the performance of several designs for inflow diffusers and inflow baffles was tested with CFD analysis. The comparative designs did not show much improvement at maximum operating flow conditions. An inflow diffuser with an octagonal design was developed (FIGS. 6A-6B) and the corresponding CFD analysis showed achievement of desired flow conditions. Uniform fluid flow distribution was achieved and there were no high turbulence and recirculation events seen inside the influent well and inside the clarifier. FIG. 6A shows a side view, a top view, and a side perspective view of the exemplary inflow diffuser 610. FIG. 6B shows a side view, a top view, and a side perspective view of the exemplary inflow diffuser 610 within an influent well 620.

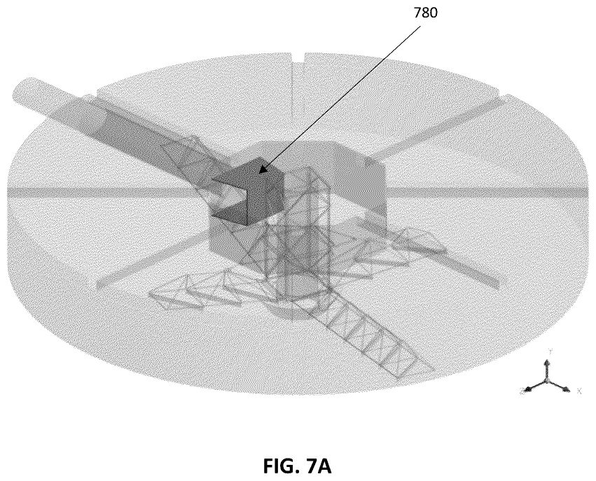

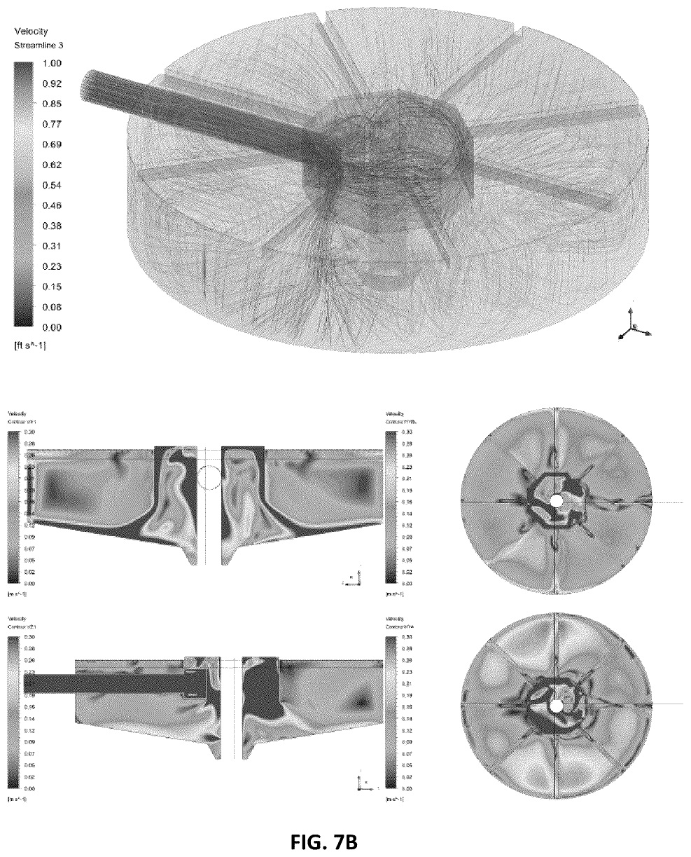

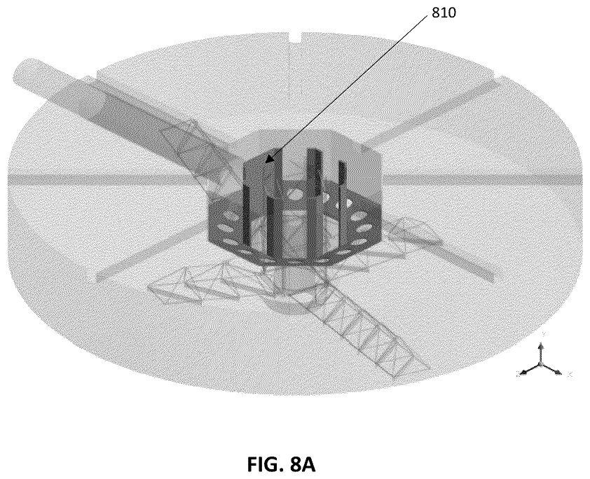

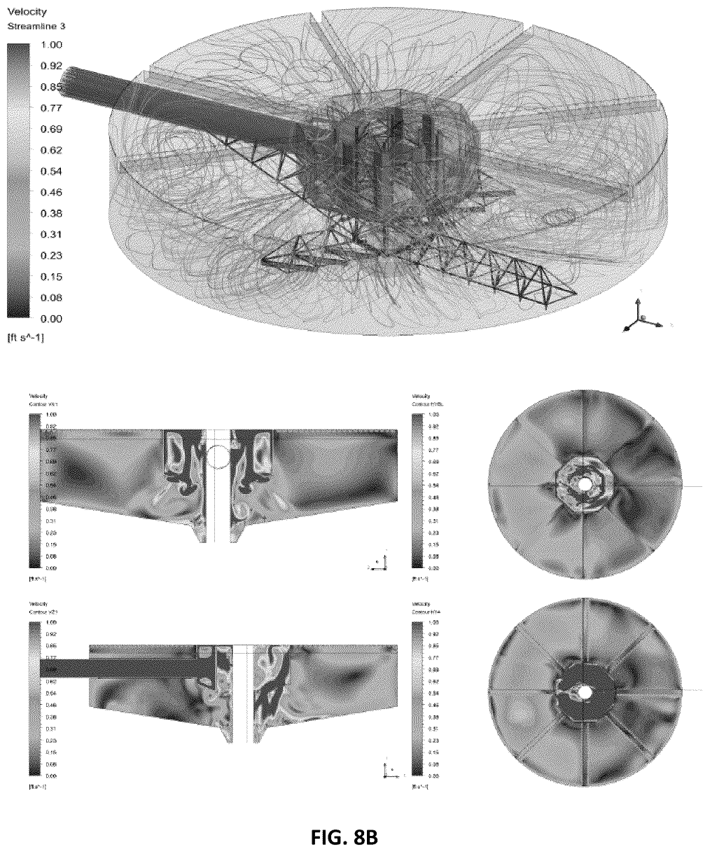

Two of the modeled designs are shown in FIGS. 7A and 8A, including the placement of the designs within a circular clarifier. In FIG. 7A, an influent baffle 780 is shown positioned in the flow path of influent wastewater within the influent well. An influent baffle, such as the one shown in FIG. 7A, is sometimes used in conventional systems. FIG. 7B shows a velocity profile of fluid inside the influent well and clarifier with influent baffle 780. As shown in FIG. 7B, the design of influent baffle 780 produces highly localized high velocity regions within the influent well and clarifier.

In FIG. 8A, an inflow diffuser 810 having an octagonal cross-sectional area is shown positioned in the flow path of influent wastewater within the influent well. FIG. 8B shows a velocity profile of fluid inside the influent well and clarifier with inflow diffuser 810. As shown in FIG. 8B, the design of inflow diffuser 810 produces more uniform high velocity flow within the influent well and clarifier. The uniform fluid flow distribution produced by inflow diffuser 810 reduces operational issues of clarifiers at maximum velocity, such as floc carryover through the outlet launder.

Thus, the inflow diffuser described herein, when operating at maximum treatment capacity, reduces or prevents high turbulence and recirculation within the influent well, achieves uniform flow distribution within the influent well and inside the clarifier, thereby reducing or preventing floc carryover through the outlet launders, enables maximum treatment capacity of the clarifier, and provides improved solid settling at maximum treatment capacity, while having a simple design for ease of fabrication and retrofitting of existing systems.

### Example 2: Radial Inflow Diffuser for Use with a Ballasted Flocculation System

CFD was used to model several inflow diffuser designs for use with a ballasted flocculation system. A radial inflow diffuser having a hollow body with a circular cross-sectional area (FIG. 2A) was shown to be superior to other modeled designs. The use of a cone-shaped influent well substructure was also shown to provide superior results. In particular, the inflow diffuser having an influent well substructure provided the desired flow conditions within the clarifier without inducing velocity spikes in the flow path.

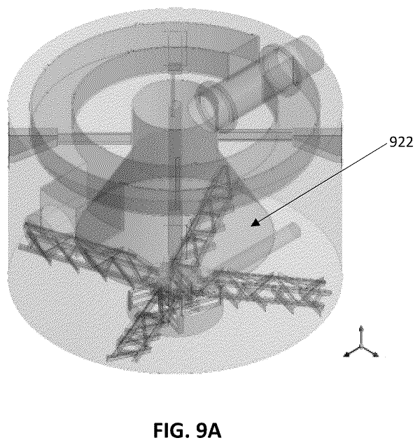

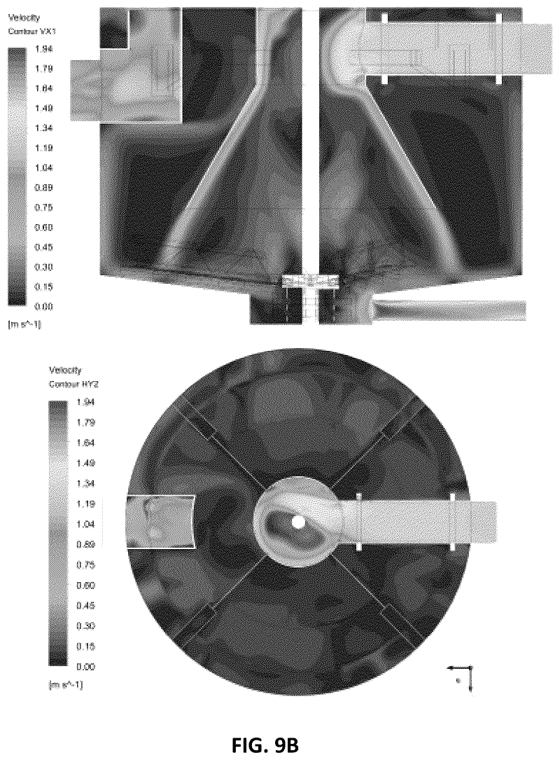

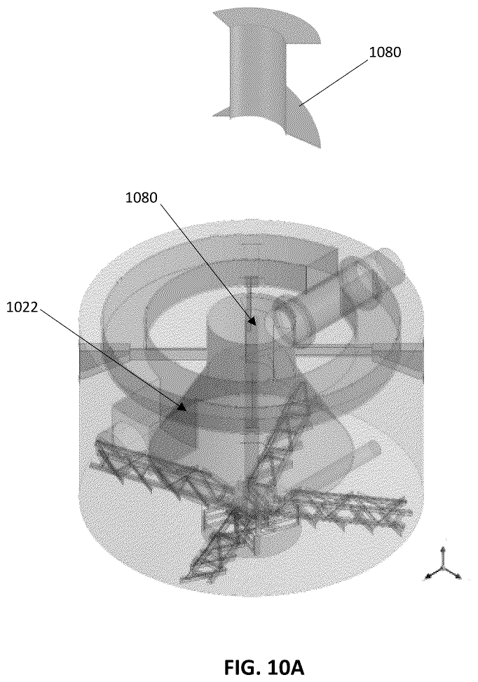

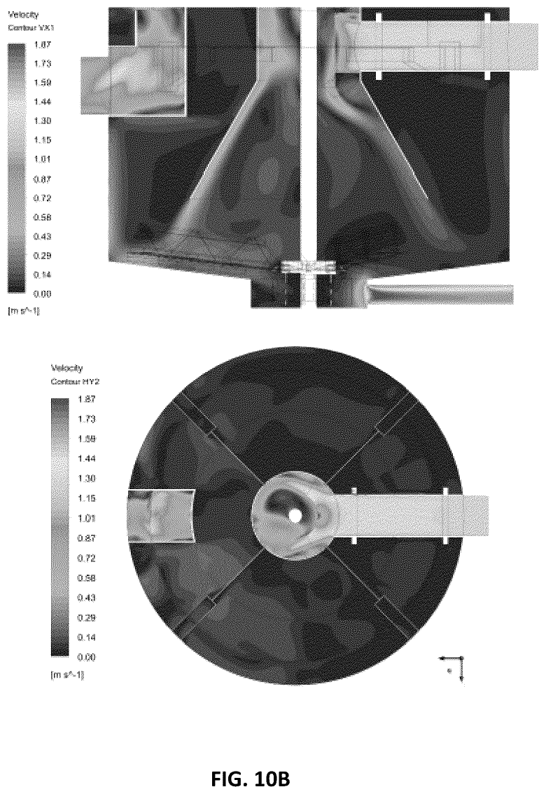

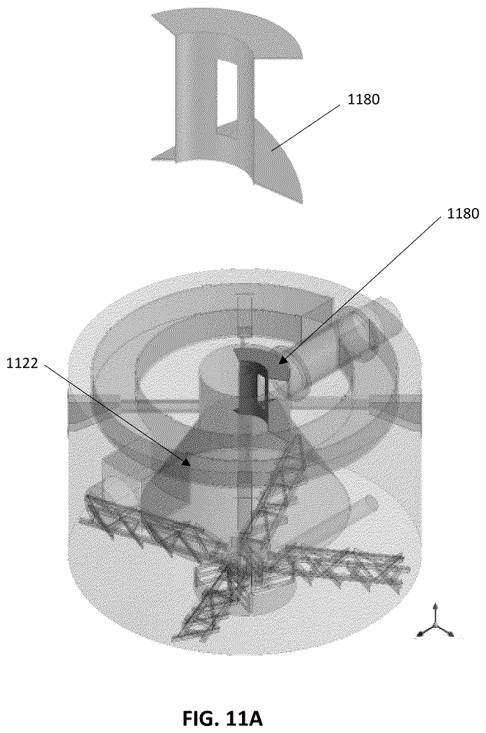

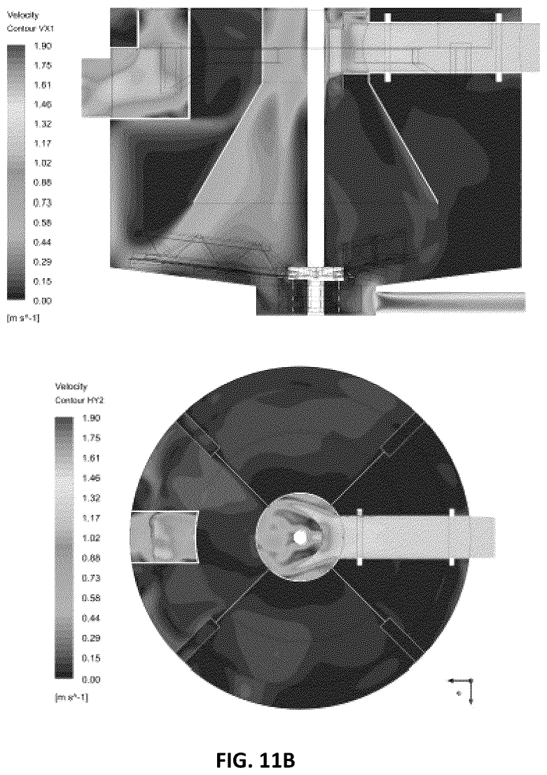

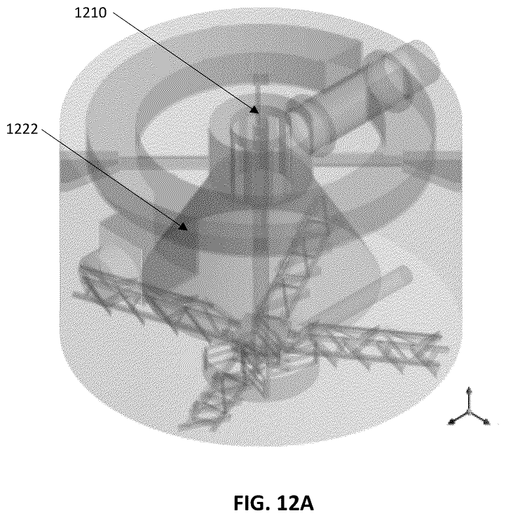

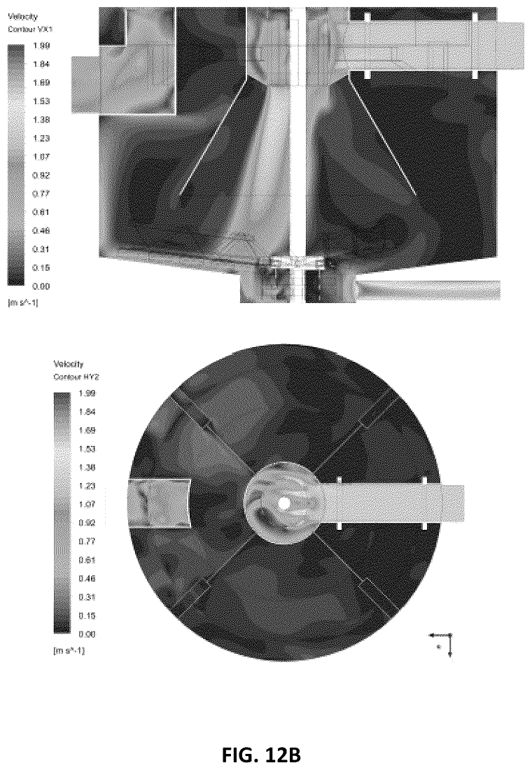

The CFD analysis was performed assuming a hypothetical clarifier operating at 3000 gpm, at an influent flow rate of 4.03 ft/s (1.23 m/s). Four modeled designs are shown in FIGS. 9A, 10A, 11A, and 12A, including the placement of the designs within a circular clarifier. In FIG. 9A, influent well substructure 922 was used with no baffle or diffuser structure in the clarifier. In FIG. 10A, influent well substructure 1022 with a semi-circular influent baffle 1080 are shown positioned in the flow path of influent wastewater within the influent well. In FIG. 11A, influent well substructure 1122 with a semi-circular influent baffle 1180 having flow distributors are shown positioned in the flow path of influent wastewater within the influent well. In FIG. 12A, influent well substructure 1222 with an influent diffuser 1210, such as the one shown in FIG. 2A, are shown positioned in the flow path of influent wastewater within the influent well.

FIGS. 9B, 10B, and 11B show the velocity profiles of fluid inside the influent well and clarifier without an influent baffle or diffuser structure, with influent baffle 1080, and with influent baffle 1180, respectively. As shown in FIGS. 9B, 10B, and 11B, the modeled designs produce highly localized high velocity regions within the influent well and clarifier.

FIG. 12B shows the velocity profile of fluid inside the influent well and clarifier with influent diffuser 1210. The inflow diffuser design achieved an average velocity at the influent well of 0.161 ft/s (0.049 m/s) and settling zone of 0.0868 ft/s (0.026 m/s). As shown in FIG. 12B, the design of inflow diffuser 1210 produces more uniform high velocity flow within the influent well and clarifier. Thus, the inflow diffuser and influent well substructure design is able to control turbulence within the influent well and reduce carry over of flocs even at a high inlet operating velocity, significantly enhancing the settling rate within the clarifier.

Accordingly, the inflow diffuser and influent well substructure were shown to achieve the desired flow conditions within the clarifier, thereby enabling increased treatment capacity as measured by increased flow rate of the clarifier, avoid stagnation of heavy magnetite particles (ballast), and provide superior results in separation of ballasted floc as compared to other modeled designs, while having a simple design for ease of fabrication and retrofitting of existing systems.

The phraseology and terminology used herein is for the purpose of description and should not be regarded as limiting. As used herein, the term “plurality” refers to two or more items or components. The terms “comprising,” “including,” “carrying,” “having,” “containing,” and “involving,” whether in the written description or the claims and the like, are open-ended terms, i.e., to mean “including but not limited to.” Thus, the use of such terms is meant to encompass the items listed thereafter, and equivalents thereof, as well as additional items. Only the transitional phrases “consisting of” and “consisting essentially of,” are closed or semi-closed transitional phrases, respectively, with respect to the claims. Use of ordinal terms such as “first,” “second,” “third,” and the like in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Having thus described several aspects of at least one embodiment, it is to be appreciated various alterations, modifications, and improvements will readily occur to those skilled in the art. Any feature described in any embodiment may be included in or substituted for any feature of any other embodiment. Such alterations, modifications, and improvements are intended to be part of this disclosure, and are intended to be within the scope of the invention. Accordingly, the foregoing description and drawings are by way of example only.

1. An apparatus for diffusing wastewater into a clarifier having a wastewater inlet fluidly connected to an influent well, the apparatus comprising:
a rotationally symmetric hollow body having a plurality of flow distributors positioned about a perimeter of the rotationally symmetric hollow body; and
a baffle extending around a bottom end portion of the rotationally symmetric hollow body;
the apparatus being dimensioned to fit within the influent well and connectable to the clarifier on a top end portion of the rotationally symmetric hollow body.

2. The apparatus of claim 1, wherein the flow distributors define apertures open to flow through of the wastewater.

3. The apparatus of claim 2, wherein the apertures cover 40%-60% of a surface area of the rotationally symmetric hollow body.

4. The apparatus of claim 2, wherein the flow distributors extend vertically about the perimeter of the rotationally symmetric hollow body.

5. The apparatus of claim 2, wherein the flow distributors form a grid structure, pattern structure, or serpentine structure, about the perimeter of the rotationally symmetric hollow body.

6. The apparatus of claim 1, wherein the baffle extends around the bottom end portion of the rotationally symmetric hollow body at an angle of 45°-75° in an upward direction.

7. The apparatus of claim 1, wherein the rotationally symmetric hollow body has a circular cross section.

8. The apparatus of claim 1, wherein the rotationally symmetric hollow body has a polygonal cross section.

9. The apparatus of claim 8, wherein the rotationally symmetric hollow body has an octagonal cross section.

10. The apparatus of claim 1, wherein the baffle comprises a plurality of flow distributors and has a length selected to contact or extend to an interior surface of the influent well.

11. The apparatus of claim 1, further comprising an overhead baffle extending around the top end portion of the rotationally symmetric hollow body.

12. The apparatus of claim 1, wherein the apparatus is connectable to the clarifier by a coupler positioned on the top end portion of the rotationally symmetric hollow body.

13. The apparatus of claim 1, being dimensioned to fit surrounding a shaft positioned upright in the clarifier.

14. A wastewater treatment system comprising:
a clarifier having a wastewater inlet fluidly connected to an influent well and a shaft positioned upright in the clarifier; and
an apparatus for diffusing wastewater into the clarifier comprising a rotationally symmetric hollow body surrounding the shaft and a baffle extending around a bottom end portion of the rotationally symmetric hollow body,
the apparatus positioned within the influent well in a flow path of the wastewater introduced through the wastewater inlet.

15. The system of claim 14, wherein the apparatus comprises a plurality of flow distributors positioned about a perimeter of the rotationally symmetric hollow body.

16. The system of claim 15, wherein the apparatus has an exterior diameter that is between about 40%-100% of an interior diameter of the influent well.

17. The system of claim 14, wherein the clarifier is a circular clarifier.

18. The system of claim 17, wherein the wastewater inlet is a lateral wastewater inlet.

19. The system of claim 14, wherein the influent well comprises an influent well substructure having a flared bottom.

20. The system of claim 19, wherein the influent well substructure is flared at an angle of between about 15°-75°.

21. The system of claim 19, wherein the influent well substructure has a length that is between about 30%-150% of a height of the influent well.

22. The system of claim 14, wherein the rotationally symmetric hollow body has a circular cross section.

23. The system of claim 14, wherein the rotationally symmetric hollow body has an octagonal cross section.

24. A method of retrofitting a circular clarifier having a lateral wastewater inlet fluidly connected to an influent well and a shaft positioned upright in the clarifier, the method comprising:
providing an apparatus for diffusing wastewater into the circular clarifier comprising a rotationally symmetric hollow body having a plurality of flow distributors positioned about a perimeter of the rotationally symmetric hollow body and a baffle extending around a bottom end portion of the rotationally symmetric hollow body; and
positioning the apparatus within the influent well surrounding the shaft in a flow path of the wastewater introduced through the lateral wastewater inlet.

25. The method of claim 24, further comprising providing an influent well substructure having a flared bottom and securing the influent well substructure below a bottom portion of the influent well.

26. The method of claim 24, further comprising controlling flow rate of the wastewater introduced through the lateral wastewater inlet to be greater than 1.15 m/s.
